(19) United States
(12) Patent Application Publication
(10) Pub. No.: US 2026/0267417 A1
(43) Pub. Date: Sep. 10, 2026

(54) HAPTIC ACTUATOR MODULE IN AN ELECTRONIC DEVICE

(71) Applicant: Semtech Corporation, Camarillo, CA (US)

(72) Inventors: Ilya Rosenberg, Sunnyvale, CA (US); Omar Leung, Palo Alto, CA (US); Julius Minglin Tsai, San Jose, CA (US); Nandinee Kaushik, San Jose, CA (US)

(21) Appl. No.: 19/558,421

(22) Filed: Mar. 5, 2026

Related U.S. Application Data
(60) Provisional application No. 63/862,396, filed on Aug. 12, 2025.
(60) Provisional application No. 63/767,113, filed on Mar. 5, 2025.

(51) Int. Cl. G06F 3/01; G06F 3/041; H01F 27/02; H01F 27/28

(52) U.S. Cl. CPC G06F 3/016; G06F 3/0414; H01F 27/027; H01F 27/2804; H01F 27/2809

(57) ABSTRACT

A haptic actuator module in an electronic device is disclosed. Herein, the haptic actuator module includes one or more permanent magnets and one or more electromagnetic coils that can be configured to collectively generate a haptic force in a desired direction. In embodiments disclosed herein, the electromagnetic coils can be disposed based on an out-of-plane or an in-plane configuration relative to the permanent magnets. As such, the haptic actuator module can be more compact than conventional haptic actuators. In addition, by sandwiching the haptic actuator module between a supporting structure and a touch surface in a haptic actuation device, it is possible to minimize any resonance of the haptic actuator module and allow the touch surface to dominate the resonance felt by an end user. As a result, the haptic actuation device can create a wide range of haptic effects in the electronic device across a wider band of frequencies.

### FIELD OF THE DISCLOSURE

The technology of the disclosure relates generally to a haptic actuator module (e.g., a direct drive actuator module) that can provide a haptic response in an electronic device.

### BACKGROUND

Modern user interfaces in electronic devices (e.g., smartphones, tablets, laptop computers, game controllers, automobile infotainment systems, etc.) are transitioning from mechanical buttons toward touch-based user interfaces. The prevalence of the touch-based user interfaces is driven in part by advancement in touchscreens, strain-based force sensors, and haptic technologies, whereby user interactions with a touch surface can be emulated by a combination of touch sensing, force sensing, and haptic output.

The haptic output is typically generated by means of a haptic actuator. Conventional haptic actuators like eccentric rotating mass (ERM) actuators, linear resonant actuators (LRAs), and piezo actuators all have noticeable shortcomings that make it difficult for integration into most applications. Specifically, the ERM actuator and LRA are often bulky, expensive, and power hungry. Moreover, the haptic output generated by the ERM actuator and LRA can create a buzzy sensation that may be noisy and unpleasant to an end user. Furthermore, both types of actuators typically have a high-Q factor, which can produce a strong response only within a narrow band of frequencies but are unable to reproduce more complex waveforms with a wide range of frequencies. The piezo actuator, on the other hand, is more difficult to drive electrically due to ceramic-based construction. In addition, the piezo actuator also tends to have relatively high resonant frequencies and is unable to produce low frequency vibrations.

A promising alternative to the conventional haptic actuators is a direct drive actuator (DDA), which can create a better haptic effect by pushing directly on the touch surface. Unfortunately, a compact and low-cost DDA is not readily available due to limitations in available designs. As such, it is desired to create a compact and low-cost haptic actuator module that is less buzzy and can reproduce a strong haptic output across a wide range of desired frequencies. Moreover, the haptic actuator module should be made as compact as possible to accommodate a variety of electronic devices and/or applications.

### SUMMARY

Embodiments of the disclosure relate to a haptic actuator module in an electronic device. Herein, the haptic actuator module includes one or more permanent magnets and one or more electromagnetic coils that can be configured to collectively generate a haptic force in a desired direction (e.g., vertical or horizontal). In embodiments disclosed herein, the electromagnetic coils can be disposed based on an out-of-plane or an in-plane configuration relative to the permanent magnets. As such, the haptic actuator module can be more compact than conventional haptic actuators. In addition, by sandwiching the haptic actuator module between a supporting structure and a touch surface in a haptic actuation device, it is possible to minimize any resonance of the haptic actuator module and allow the touch surface to dominate the resonance felt by an end user. As a result, the haptic actuation device can create a wide range of haptic effects in the electronic device across a wider band of frequencies.

In one aspect, a haptic actuation device is provided. The haptic actuation device includes a touch surface and a supporting structure. The touch surface and the supporting structure are disposed in parallel to each other. The haptic actuation device also includes a haptic actuator module. The haptic actuator module is disposed between the touch surface and the supporting structure. The haptic actuator module is configured to generate an actuation force. The haptic actuator module includes at least one permanent magnet disposed on the supporting structure. The haptic actuator module also includes at least one electromagnetic coil defining a central aperture vertically aligned with the at least one permanent magnet and sized larger than the at least one permanent magnet such that the at least one electromagnetic coil will not physically contact the at least one permanent magnet when moving into coplanarity with the at least one permanent magnet.

In another aspect, a wireless device is provided. The wireless device includes a haptic actuation device. The haptic actuation device includes a touch surface and a supporting structure. The touch surface and the supporting structure are disposed in parallel to each other. The haptic actuation device also includes a haptic actuator module. The haptic actuator module is disposed between the touch surface and the supporting structure. The haptic actuator module is configured to generate an actuation force. The haptic actuator module includes at least one permanent magnet disposed on the supporting structure. The haptic actuator module also includes at least one electromagnetic coil defining a central aperture vertically aligned with the at least one permanent magnet and sized larger than the at least one permanent magnet such that the at least one electromagnetic coil will not physically contact the at least one permanent magnet when moving into coplanarity with the at least one permanent magnet.

In another aspect, a haptic actuation device is provided. The haptic actuation device includes a touch surface and a supporting structure. The touch surface and the supporting structure are disposed in parallel to each other. The haptic actuation device also includes a haptic actuator module. The haptic actuator module is disposed between the touch surface and the supporting structure. The haptic actuator module is configured to generate an actuation force. The haptic actuator module includes at least two permanent magnets disposed on the supporting structure. The haptic actuator module also includes at least one electromagnetic coil disposed between the at least two permanent magnets and coplanar with the at least two permanent magnets, the at least one electromagnetic coil defines a central aperture dimensioned independently of the at least two permanent magnets.

In another aspect, a wireless device is provided. The wireless device includes a haptic actuation device. The haptic actuation device includes a touch surface and a supporting structure. The touch surface and the supporting structure are disposed in parallel to each other. The haptic actuation device also includes a haptic actuator module. The haptic actuator module is disposed between the touch surface and the supporting structure. The haptic actuator module is configured to generate an actuation force. The haptic actuator module includes at least two permanent magnets disposed on the supporting structure. The haptic actuator module also includes at least one electromagnetic coil disposed in between the at least two permanent magnets and coplanar with the at least two permanent magnets. The at least one electromagnetic coil defines a central aperture dimensioned independently of the at least two permanent magnets.

In another aspect, a method for assembling a haptic actuation device is provided. The method includes preassembling a haptic actuator module. The method also includes forming a slot on a supporting structure with a shape corresponding to that of the haptic actuator module. The method also includes disposing the haptic actuator module into the slot and adhering a housing of the haptic actuator module to the supporting structure. The method also includes adhering a multi-layer coil circuit in the haptic actuator module to a touch surface. The method also includes pressing the housing of the haptic actuator module to securely bound the haptic actuator module with the supporting structure and the touch surface. The method also includes making an electrical connection to the haptic actuator module.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an exemplary haptic actuation device wherein a haptic actuator module can be provided between a top surface and a supporting structure according to various embodiments of the present disclosure to generate an actuation force in a desired direction;

FIG. 2 is a graphic diagram comparing a resonant frequency bandwidth between the haptic actuator module in FIG. 1 and a conventional linear resonant actuator (LRA);

FIGS. 3A-3D are schematic diagrams illustrating operating principles of the haptic actuator module in FIG. 1 configured according to an out-of-plane configuration of the present disclosure;

FIGS. 4A-4C are schematic diagrams providing exemplary illustrations of various types of multi-layer electromagnetic coil that can be provided in the haptic actuator module assembled based on the out-of-plan configuration in FIGS. 3A-3D to boost the actuation force;

FIGS. 5A-5B are schematic diagrams providing exemplary illustrations of a dual-coil haptic actuator module incorporating a pair of the haptic actuator modules assembled based on the out-of-plan configuration in FIGS. 3A-3D to boost the actuation force;

FIG. 6 is a schematic diagram of an exemplary multi-coil haptic actuator module assembled based on the dual-coil haptic actuator module in FIGS. 5A-5B to further boost the actuation force;

FIGS. 7A-7B are schematic diagrams illustrating how the haptic actuation device of FIG. 1 can be assembled with the dual-coil haptic actuator module of FIGS. 5A-5B;

FIGS. 8A-8B are schematic diagrams illustrating how the haptic actuation device of FIG. 1 can be assembled with the dual-coil haptic actuator module of FIGS. 5A-5B and detect a deflection of the touch surface;

FIGS. 9A-9D are schematic diagrams illustrating operating principles of the haptic actuator module in FIG. 1 configured according to an in-plane configuration of the present disclosure;

FIGS. 10A-10B are schematic diagrams providing exemplary illustrations of a dual-coil haptic actuator module incorporating a pair of the haptic actuator modules assembled based on the in-plane configuration in FIGS. 9A-9D to boost the actuation force;

FIG. 11 is a schematic diagram of an exemplary multi-coil haptic actuator module assembled based on the dual-coil haptic actuator module in FIGS. 10A-10B to further boost the actuation force;

FIGS. 12A-12B are schematic diagrams illustrating how the haptic actuation device of FIG. 1 can be assembled based on the in-plane configuration of FIGS. 9A-9B;

FIG. 13 is a schematic diagram of an exemplary communication device wherein the haptic actuation device of FIG. 1 can be provided; and

FIG. 14 is a flowchart of an exemplary process for assembling the haptic actuation device of FIG. 1.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term "and/or" includes any and all combinations of one or more of the associated listed items.

It will be understood that when an element such as a layer, region, or substrate is referred to as being "on" or extending "onto" another element, it can be directly on or extend directly onto the other element or intervening elements may also be present. In contrast, when an element is referred to as being "directly on" or extending "directly onto" another element, there are no intervening elements present. Likewise, it will be understood that when an element such as a layer, region, or substrate is referred to as being "over" or extending "over" another element, it can be directly over or extend directly over the other element or intervening elements may also be present. In contrast, when an element is referred to as being "directly over" or extending "directly over" another element, there are no intervening elements present. It will also be understood that when an element is referred to as being "connected" or "coupled" to another element, it can be directly connected or coupled to the other element or intervening elements may be present. In contrast, when an element is referred to as being "directly connected" or "directly coupled" to another element, there are no intervening elements present.

Relative terms such as "below" or "above" or "upper" or "lower" or "horizontal" or "vertical" may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms "a," "an," and "the" are intended to include the plural forms as well, unless the context clearly indicates otherwise. It will be further understood that the terms "comprises," "comprising," "includes," and/or "including" when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the disclosure relate to a haptic actuator module in an electronic device. Herein, the haptic actuator module includes one or more permanent magnets and one or more electromagnetic coils that can be configured to collectively generate a haptic force in a desired direction (e.g., vertical or horizontal). In embodiments disclosed herein, the electromagnetic coils can be disposed based on an out-of-plane or an in-plane configuration relative to the permanent magnets. As such, the haptic actuator module can be more compact than conventional haptic actuators. In addition, by sandwiching the haptic actuator module between a supporting structure and a touch surface in a haptic actuation device, it is possible to minimize any resonance of the haptic actuator module and allow the touch surface to dominate the resonance felt by an end user. As a result, the haptic actuation device can create a wide range of haptic effects in the electronic device across a wider band of frequencies.

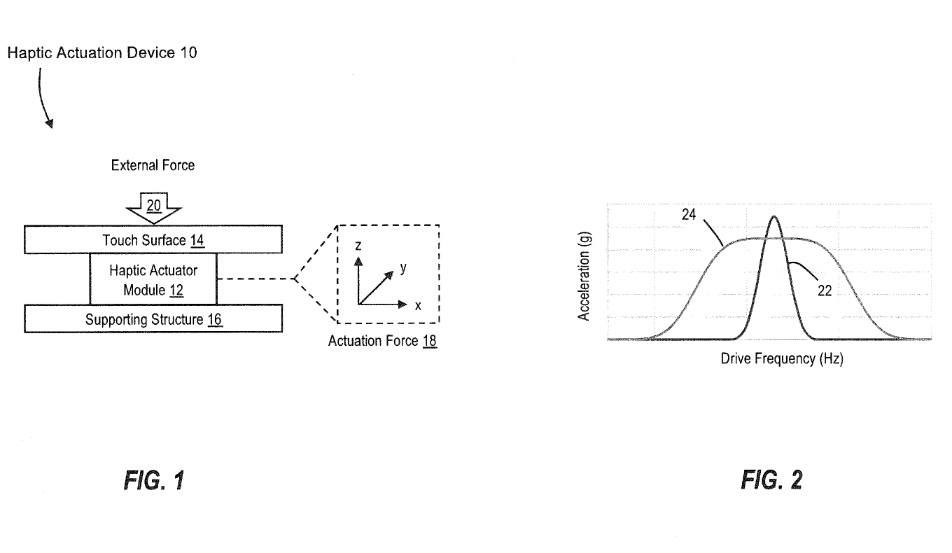

FIG. 1 is a schematic diagram of an exemplary haptic actuation device 10 wherein a haptic actuator module 12 can be provided with a touch surface 14 (e.g., a touchscreen) and a supporting structure 16 (e.g., a bracket or a midframe) according to various embodiments of the present disclosure to generate an actuation force 18 in a desired direction. The haptic actuator module 12 is disposed in between the touch surface 14 and the supporting structure 16. By providing the haptic actuator module 12 between the touch surface 14 and the supporting structure 16, the haptic actuator module 12 can generate the actuation force 18 along an x-axis, y-axis, or z-axis in a three-dimensional Cartesian coordinate system, depending on specific electronic devices and/or applications to be supported.

In this regard, the haptic actuation device 10 can function as a direct drive actuator (DDA) device. In one example, the haptic actuator module 12 can be configured to generate the actuation force 18 perpendicular to the touch surface 14 to thereby create a displacement in the touch surface 14 (a.k.a. z-axis) when an external force 20 (e.g., a finger press) is applied onto the touch surface 14. In another example, the haptic actuator module 12 may also be configured to generate the actuation force 18 in parallel to the touch surface 14 to thereby create a displacement along the x-axis or the y-axis.

The haptic actuator module 12 can be configured to generate the actuation force 18 over a much wider band of frequencies compared to a conventional linear resonant actuator (LRA). FIG. 2 is a graphic diagram comparing a resonant frequency bandwidth between the haptic actuator module 12 in FIG. 1 and a conventional LRA.

When the LRA is used in place of the haptic actuator module 12 to create a haptic effect on the touch surface 14, the LRA can only be attached to the touch surface 14 and the supporting structure 16 needs to be removed. As such, the LRA cannot push the touch surface 14 directly. Instead, the LRA must vibrate a mass and pass that vibration onto the touch surface 14. Notably, the touch surface 14 and the LRA can each have a respective resonant frequency that can change over time due to variations in temperature, age, and other conditions. As a result, it is difficult to match the two resonant frequencies to pass the vibration from the LRA onto the touch surface 14 over a wider range of resonant frequencies. As illustrated by a first graph 22, the LRA can only be driven across an LRA bandwidth of approximately 10 Hz (e.g., 175-185 Hz).

In contrast, by providing the haptic actuator module 12 between the touch surface 14 and the supporting structure 16, the haptic actuator module 12 can minimize any resonance. As such, only the touch surface 14 will resonate at its natural resonant frequency that dominates an end user experience. In this regard, there is no longer a need to match the natural resonant frequency of the touch surface 14 with the resonant frequency of the haptic actuator module 12. As a result, it is easier to drive the haptic actuator module 12 to produce the actuation force 18 over a wider range of frequencies. As illustrated herein by a second graph 24, the haptic actuator module 12 can be driven across a frequency bandwidth of approximately 150 Hz (e.g. 100-250 Hz). In this regard, the haptic actuator module 12 can outperform the conventional LRA in terms of the resonant frequency bandwidth.

The haptic actuator module 12 is configured to generate the actuation force 18 by means of electromagnetic actuation. Specifically, the haptic actuator module 12 includes one or more permanent magnets disposed on the supporting structure 16 and one or more electromagnetic coils disposed on the touch surface 14. As further described below, the electromagnetic coils can be placed relative to the permanent magnets based either on an out-of-plane or an in-plane configuration. Accordingly, the electromagnetic coils can interact with magnetic field lines of the permanent magnets to thereby generate the actuation force 18 in the desired direction to create the displacement on the touch surface 14.

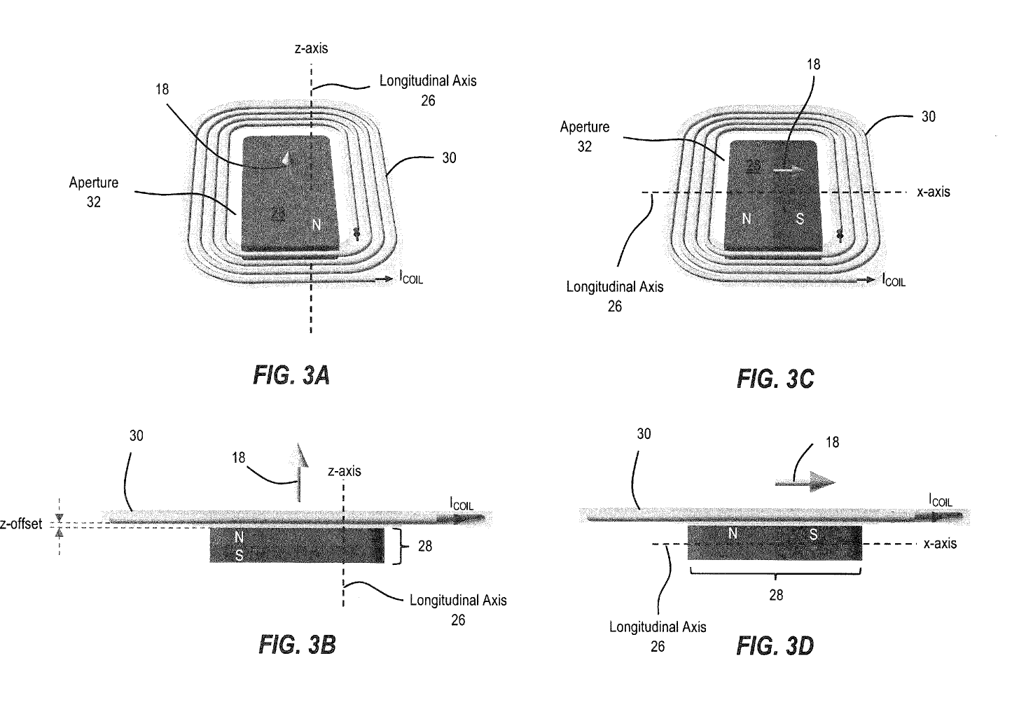

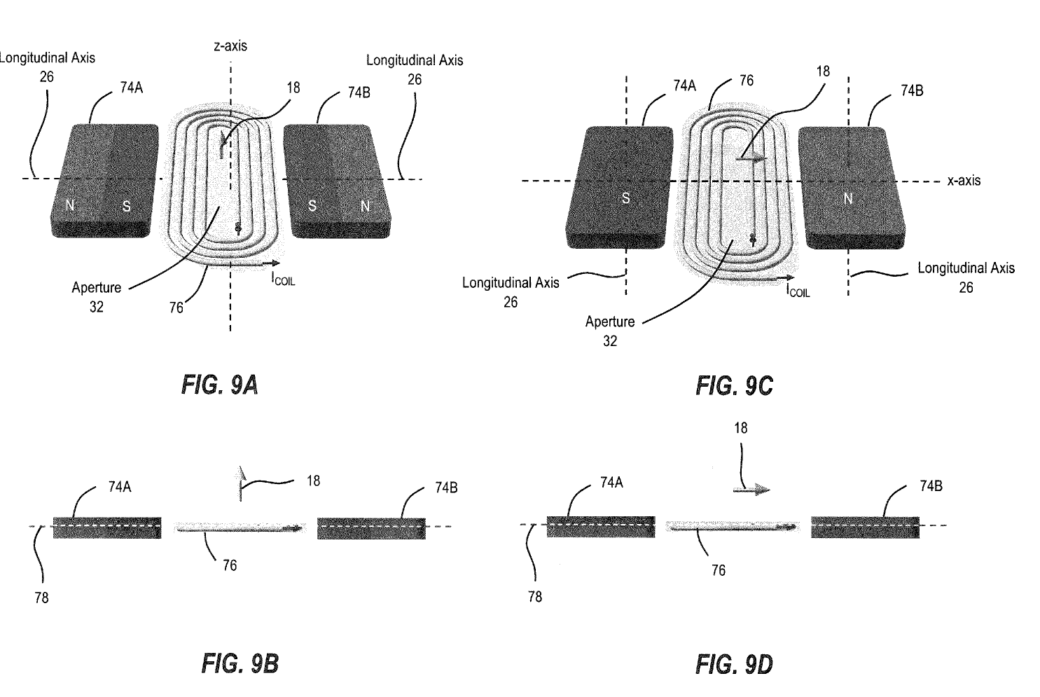

Aspects related to the haptic actuation device 10 implemented based on the out-of-plane configuration are further described with reference to FIGS. 3A-3D, 4A-4C, 5A-5B, 6, 7A-7C, and 8A-8C. Aspects related to the haptic actuation device 10 implemented based on the in-plane configuration are further described with reference to FIGS. 9A-9D, 10A-10B, 11, and 12A-12C. Common elements between FIGS. 1, 3A-3D, 4A-4C, 5A-5B, 6, 7A-7C, 8A-8C, 9A-9D, 10A-10B, 11, and 12A-12C are shown therein with common element numbers and will not be re-described herein.

FIGS. 3A-3D are schematic diagrams illustrating operating principles of the haptic actuator module 12 in FIG. 1 when the haptic actuator module 12 is configured according to the out-of-plane configuration. Specifically, FIGS. 3A and 3B illustrate how the haptic actuator module 12 can be configured to generate the actuation force 18 along a longitudinal axis 26 that coincides with the z-axis, whereas FIGS. 3C and 3D illustrate how the haptic actuator module 12 can be configured to generate the actuation force 18 along the longitudinal axis 26 that coincides with either the x-axis or the y-axis.

With reference to FIG. 3A, the haptic actuator module 12 configured based on the out-of-plane configuration includes a permanent magnet 28 and an electromagnetic coil 30. Herein, the electromagnetic coil 30 is a rectangular shaped coil that defines an aperture 32. However, it should be appreciated that the electromagnetic coil 30 can also be formed in other suitable shapes, such as circular shaped, square shaped, and so on.

FIG. 3B illustrates a cross-section view of the haptic actuator module 12 of FIG. 3A. Herein, a north pole (denoted as “N”) of the permanent magnet 28 is on top of a south pole (denote as “S”) of the permanent magnet 28. In this regard, when an electrical current I_{COIL} flows counterclockwise through the electromagnetic coil 30, the actuation force 18 will be pointing upward. In contrast, when the electrical current I_{COIL} flows clockwise through the electromagnetic coil 30, the actuation force 18 will be pointing downward.

As the name “out-of-plane” suggests, the electromagnetic coil 30 is positioned slightly above the permanent magnet 28, as opposed to being in the same plane as the permanent magnet 28. In an embodiment, the electromagnetic coil 30 is vertically separated from the permanent magnet 28 by a vertical distance z-offset of approximately one-quarter (¼) to one-half (½) the thickness of the permanent magnet 28.

Studies have shown that, by vertically separating the electromagnetic coil 30 from the permanent magnet 28, the actuation force 18 can be the strongest. Nevertheless, the haptic actuator module 12 can still generate the actuation force 18 in a weaker degree when the electromagnetic coil 30 is placed in coplanarity with the permanent magnet 28. In this regard, the aperture 32 of the electromagnetic coil 30 should be larger than the size of the permanent magnet 28 such that the electromagnetic coil 30 will not physically contact the permanent magnet 28 when the electromagnetic coil 30 moves into coplanarity with the permanent magnet 28.

With reference to FIGS. 3C and 3D, to generate the actuation force 18 along the longitudinal axis 26 that coincides with the x-axis, the permanent magnet 28 is polarized with the north pole (N) on the left and the south pole (S) on the right, and the electrical current I_{COIL} still flows counterclockwise through the electromagnetic coil 30. As a result, the actuation force 18 will be pointing to the right. To make the longitudinal axis 26 coincide with the y-axis, the haptic actuator module 12 can simply be rotated by 90° counterclockwise or clockwise.

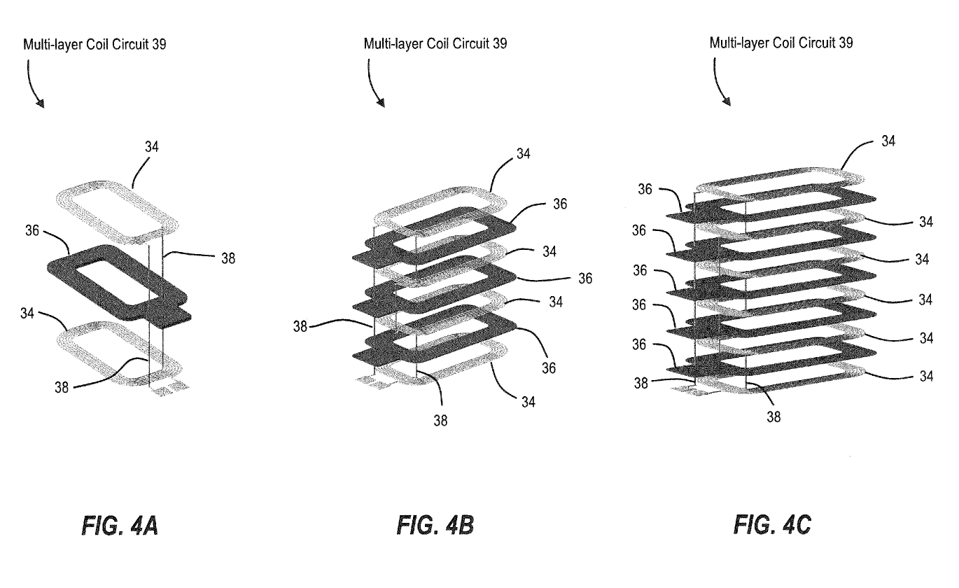

In an embodiment, the electromagnetic coil 30 can be wound more tightly and/or configured with multiple layers to help boost the actuation force 18. In this regard, FIGS. 4A-4C are schematic diagrams providing exemplary illustrations as to how the haptic actuator module 12 assembled based on the out-of-plan configuration in FIGS. 3A-3D can be configured to boost the actuation force 18.

Specifically, FIG. 4A illustrates the electromagnetic coil 30 configured with two layers 34. The layers 34 are provided on a printed circuit board (PCB) 36 and electrically coupled to each other via one or more vias 38 to thereby form a multi-layer coil circuit 39. The vias 38 can be used to route the coil current I_{COIL} to the electromagnetic coil 30 to thereby ensure a correct winding direction of the electromagnetic coil 30 on each of the layers 34.

FIG. 4B illustrates the electromagnetic coil 30 configured with four layers 34, which are provided on three PCBs 36 and electrically coupled using the vias 38, to thereby form the multi-layer coil circuit 39 to further increase efficiency and boost the actuation force 18. For the purpose of this illustration, the vias 38, which can be buried or blind, are used to interconnect each of the layers 34. It should be appreciated that, however, it is also possible to interconnect the layers 34 using through-hole vias as long as such vias are carefully arranged not to inadvertently short any layer that is not meant to be connected.

FIG. 4C illustrates the electromagnetic coil 30 configured with six layers 34, which are provided on five PCBs 36 and electrically coupled using the vias 38 to thereby form the multi-layer coil circuit 39. With more of the layers 34 being added into the electromagnetic coil 30, factors such as trace width, copper thickness, number of turns of copper, and number of layers may be explored to control haptic output and impedance of the design. Similarly, for a design with wound copper, diameter of the copper and number of turns may be used to control the haptic output and the impedance of the design.

Notably, FIGS. 4A-4C are merely non-limiting examples, which shall not be interpreted as being exclusive and limiting. Typically, the desired haptic output is driven by stiffness of the touch surface 14 that is being actuated and requirements of the design. The impedance requirement, on the other hand, is driven by the system architecture and characteristics of a circuit used to drive the haptic actuator module 12.

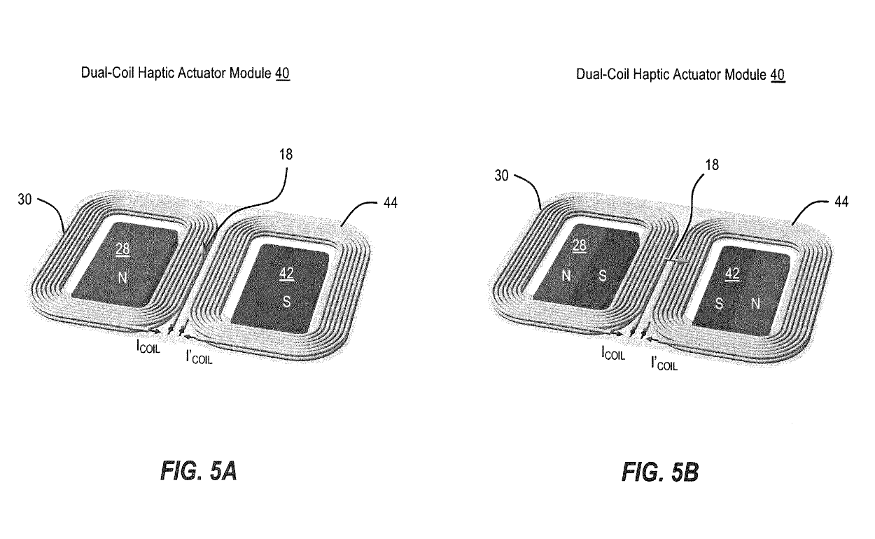

In another embodiment, it is also possible to boost the actuation force 18 in the haptic actuator module 12 by incorporating more permanent magnets and electromagnetic coils. In this regard, FIGS. 5A-5B are schematic diagrams providing exemplary illustrations as to how the haptic actuator module 12 assembled based on the out-of-plan configuration in FIGS. 3A-3D can be configured to boost the actuation force 18 according to another embodiment of the present disclosure.

FIG. 5A illustrates a dual-coil haptic actuator module 40 that can boost the actuation force 18 along the z-axis. In this embodiment, the dual-coil haptic actuator module 40 further includes a second permanent magnet 42 and a second electromagnetic coil 44, which are disposed adjacent to the permanent magnet 28 and the electromagnetic coil 30. Like the electromagnetic coil 30, the second electromagnetic coil 44 can be made with multiple layers as illustrated in FIGS. 4A-4C. Herein, the second permanent magnet 42 has an opposing polarity to the permanent magnet 28. In this regard, the second permanent magnet 42 has the south pole (S) on top of the north pole (N). In addition, the second electromagnetic coil 44 has a second electrical current I’_{COIL} flowing clockwise through the second electromagnetic coil 44. As such, the dual-coil haptic actuator module 40 can constructively boost the actuation force 18 between the permanent magnet 28 and the second permanent magnet 42 along the z-axis.

FIG. 5B illustrates the dual-coil haptic actuator module 40 that can boost the actuation force 18 along the x-axis. Herein, the second permanent magnet 42 also has an opposing polarity to the permanent magnet 28. In this regard, the south pole (S) of the permanent magnet 28 is facing toward the south pole (S) of the second permanent magnet 42, whereas the north pole (N) of the permanent magnet 28 is facing away from the north pole (N) of the second permanent magnet 42. Herein, the second electromagnetic coil 44 has the second electrical current I’_{COIL} flowing clockwise therethrough. As a result, the dual-coil haptic actuator module 40 can constructively boost the actuation force 18 along the x-axis.

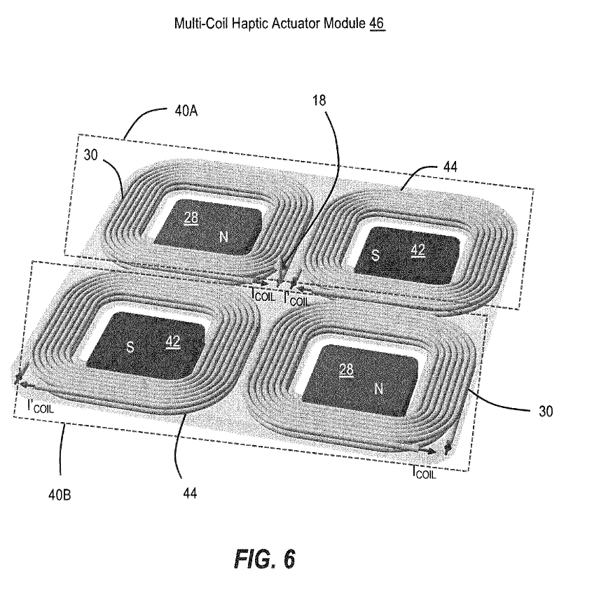

In an embodiment, it is possible to construct a multi-coil haptic actuator module based on the dual-coil haptic actuator module 40 to further boost the actuation force 18. In this regard, FIG. 6 is a schematic diagram of an exemplary multi-coil haptic actuator module 46 assembled based on the dual-coil haptic actuator module 40 in FIGS. 5A-5B to further boost the actuation force 18 along the z-axis.

Herein, the multi-coil haptic actuator module 46 includes a first dual-coil haptic actuator module 40A and a second dual-coil haptic actuator module 40B, each identical to the dual-coil haptic actuator module 40 of FIG. 5A. To ensure that the first dual-coil haptic actuator module 40A and the second dual-coil haptic actuator module 40B can constructively boost the actuation force 18 along the z-axis, each adjacent pair of the permanent magnet 28 and the second permanent magnet 42 need to have opposing polarities. In addition, the electrical current I_{COIL} and the second electrical current I’_{COIL} must flow in opposite directions in each adjacent pair of the electromagnetic coil 30 and the second electromagnetic coil 44. Notably, the multi-coil haptic actuator module 46 is presented herein merely as a non-limiting example. It should be appreciated that the multi-coil haptic actuator module 46 can be adapted to incorporate any additional number of the dual-coil haptic actuator module 40.

In an alternative embodiment, each of the electromagnetic coil 30 and the second electromagnetic coil 44 may be individually driven to generate the actuation force 18. In this embodiment, the actuation force 18 may be weaker than the actuation force 18 so generated with all of the electromagnetic coil 30 and the second electromagnetic coil 44 being driven concurrently. Nevertheless, it may be possible to provide variations of haptic amplitude across the touch surface 14.

Although the first dual-coil haptic actuator module 40A and the second dual-coil haptic actuator module 40B are each identical to the dual-coil haptic actuator module 40 of FIG. 5A, it should be appreciated that it is also possible to make each of the first dual-coil haptic actuator module 40A and the second dual-coil haptic actuator module 40B to be identical to the dual-coil haptic actuator module 40 of FIG. 5B. As such, the multi-coil haptic actuator module 46 will be able to boost the actuation force 18 along the x-axis or the y-axis.

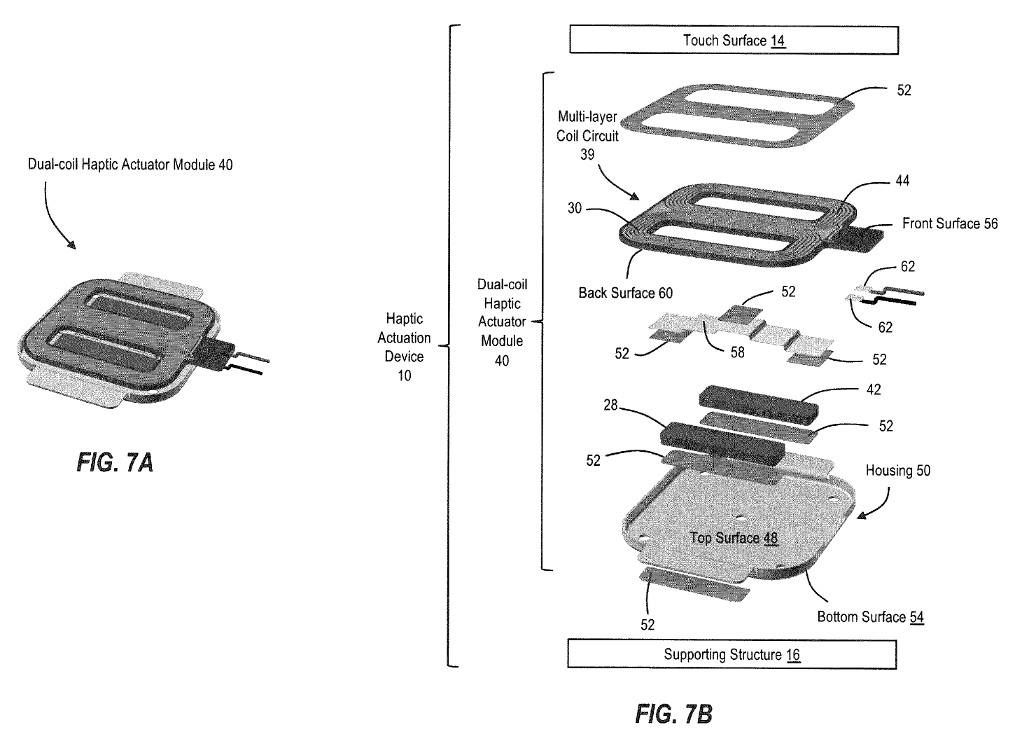

In an embodiment, the dual-coil haptic actuator module 40 as illustrated in FIGS. 5A and 5B can be provided as the haptic actuator module 12 in the haptic actuation device 10 of FIG. 1. In this regard, FIGS. 7A-7B are schematic diagrams illustrating how the haptic actuation device 10 of FIG. 1 can be assembled with the dual-coil haptic actuator module 40 of FIGS. 5A-5B.

FIG. 7A illustrates the dual-coil haptic actuator module 40 that has been preassembled according to an embodiment of the present disclosure and is ready to be provided in the haptic actuation device 10 of FIG. 1 to function as the haptic actuator module 12.

FIG. 7B provides an exploded view of the dual-coil haptic actuator module 40 of FIG. 7A. Herein, the permanent magnet 28 and the second permanent magnet 42 are adhered to a top surface 48 of a housing 50 using an adhesive material 52. In a non-limiting example, the adhesive material 52 can be pressure sensitive adhesive (PSA), glue, and other adhesion/fixation materials. A bottom surface 54 of the housing 50 will be adhered to the supporting structure 16 in the haptic actuation device 10 using the adhesive material 52.

The multi-layer coil circuit 39, which can be preconfigured with one or more layers of the electromagnetic coil 30 and the second electromagnetic coil 44, is provided above the permanent magnet 28 and the second permanent magnet 42 based on the out-of-plane configuration. Herein, the multi-layer coil circuit 39 is configured to be fully adhered to the touch surface 14 in the haptic actuation device 10 on a front surface 56 of the multi-layer coil circuit 39 using the adhesive material 52. In this regard, the adhesive material 52 used to adhere the multi-layer coil circuit 39 to the touch surface 14 shall cover substantially the entire front surface 56.

The dual-coil haptic actuator module 40 may also include a spring 58, which is adhered to the top surface 48 of the housing 50 and a back surface 60 of the multi-layer coil circuit 39 to thereby secure the multi-layer coil circuit 39 to the housing 50. The spring 58 may be made with very soft spring material with small spring constant or high damping. This can be achieved by adjusting a thickness/type of the spring material and a size/geometry of the spring 58. As an example, as opposed to making the spring 58 with metal, it is also possible to make the spring 58 molded from plastic with flexures designed into areas where the spring 58 needs to bend. In another example, the spring 58 can also be made of open-cell or closed-cell foams such that the spring 58 can have very low spring constants and damping. The dual-coil haptic actuator module 40 also includes a pair of wire leads 62, which can be soldered onto the multi-layer coil circuit 39 to provide electrical connectivity.

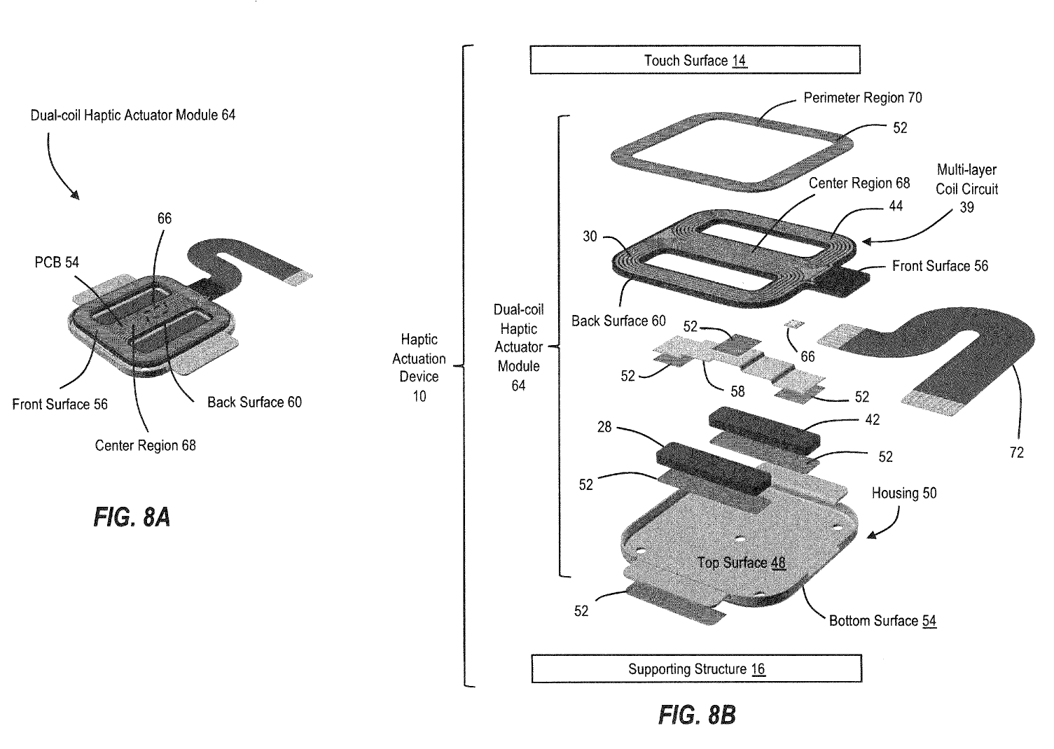

In an embodiment, it may be desired to quantify the external force 20 being applied onto the touch surface 14 to help determine an appropriate timing to provide haptic feedback to the end user. In this regard, FIGS. 8A-8B are schematic diagrams illustrating how the haptic actuation device 10 of FIG. 1 can be assembled with the dual-coil haptic actuator module 40 of FIGS. 5A-5B and configured to further detect a deflection of the touch surface 14.

FIG. 8A illustrates the dual-coil haptic actuator module 64 that has been preassembled according to an embodiment of the present disclosure and is ready to be provided in the haptic actuation device 10 of FIG. 1 to function as the haptic actuator module 12. Herein, a force sensor 66 is provided in a center region 68 and on the back surface 60 of the multi-layer coil circuit 39. When the dual-coil haptic actuator module 64 is provided in the haptic actuation device 10 to replace the haptic actuator module 12, the force sensor 66 is configured to detect a deflection of the center region 68 of the multi-layer coil circuit 39 when the external force 20 is applied onto the touch surface 14.

The dual-coil haptic actuator module 64 as illustrated in FIG. 8B is mostly the same as the dual-coil haptic actuator module 40 assembled in FIG. 7B. Nevertheless, the dual-coil haptic actuator module 64 is noticeably different from the dual-coil haptic actuator module 40 in some respects.

Besides adding the force sensor 66 in the center region 68 on the back surface 60 of the multi-layer coil circuit 39, the multi-layer coil circuit 39 is only partially adhered to the touch surface 14 along a perimeter region 70 of the front surface 56 of the multi-layer coil circuit 39. Herein, the perimeter region 70 shall not overlap with the center region 68. In addition, the adhesive material 52 used to adhere the multi-layer coil circuit 39 to the touch surface 14 can be significantly thicker than the adhesive material 52 used to adhere the multi-layer coil circuit 39 to the touch surface 14 in the dual-coil haptic actuator module 40. By making the adhesive material 52 thicker, it is possible to add sufficient room for the multi-layer coil circuit 39 to flex in response to the external force 20 being applied onto the touch surface 14, thus allowing the force sensor 66 to effectively detect the deflection in the center region 68 of the multi-layer coil circuit 39.

Another noticeable difference from the dual-coil haptic actuator module 40 is that the dual-coil haptic actuator module 64 is electrically coupled via a flex tail 72. The flex tail 72 is configured to provide electrical connections for driving the dual-coil haptic actuator module 64 and carry any signal needed by the force sensor 66. In an embodiment, the flex tail 72 may include eight pins, with two pins being used to drive the dual-coil haptic actuator module 64 and six pins being used to convey signals to and from the force sensor 66.

Alternative to preassembling the haptic actuator module 12 in FIG. 1 based on the out-of-plane configuration, it is also possible to preassemble the haptic actuator module 12 based on the in-plane configuration. In this regard, FIGS. 9A-9D are schematic diagrams illustrating operating principles of the haptic actuator module 12 in FIG. 1A when the haptic actuator module 12 is configured according to the in-plane configuration. Specifically, FIGS. 9A and 9B illustrate how the haptic actuator module 12 can be configured to generate the actuation force 18 along the z-axis, whereas FIGS. 9C and 9D illustrate how the haptic actuator module 12 can be configured to generate the actuation force 18 along the x-axis.

With reference to FIG. 9A, the haptic actuator module 12 configured based on the in-plane configuration includes a pair of permanent magnets 74A, 74B and an electromagnetic coil 76 disposed between the permanent magnets 74A and 74B. The electromagnetic coil 76 also defines the aperture 32. Unlike the aperture 32 defined by the electromagnetic coil 30 in FIGS. 3A and 3C, the aperture 32 defined by the electromagnetic coil 76 is dimensioned independently of the permanent magnets 74A and 74B.

Although the electromagnetic coil 76 is shown herein as a rectangular shaped coil, it should be appreciated that the electromagnetic coil 76 can also be formed in other suitable shapes, such as circular shaped, square shaped, and so on. Understandably, the electromagnetic coil 76 can also be configured with a suitable number of the layers 34, as illustrated in FIGS. 4A-4C, to help boost the actuation force 18.

When provided in the haptic actuation device 10, each of the permanent magnets 74A and 74B is oriented with the longitudinal axis 26 in parallel to the touch surface 14 and the supporting structure 16. The south pole (S) of each of the permanent magnets 74A and 74B is facing toward the electromagnetic coil 76, whereas the north pole (N) of each of the permanent magnets 74A and 74B is facing away from the electromagnetic coil 76. The electrical current I_{COIL} will flow counterclockwise through the electromagnetic coil 76 to thereby cause the haptic actuator module 12 to generate the actuation force 18 toward the touch surface 14 but perpendicular to the longitudinal axis 26.

FIG. 9B illustrates a cross-section view of the haptic actuator module 12 of FIG. 9A. As the name “in-plane” suggests, the electromagnetic coil 76 is positioned in coplanarity with the permanent magnet 74A and 74B. Studies have shown that the haptic actuator module 12 will generate a strongest actuation force 18 when the electromagnetic coil 76 is disposed along a center line 78 of the permanent magnets 74A and 74B.

With reference to FIGS. 9C and 9D, when provided in the haptic actuation device 10 to generate the actuation force 18 along the x-axis, the permanent magnets 74A and 74B are each oriented with the longitudinal axis 26 perpendicular to the touch surface 14 and the supporting structure 16. In addition, the permanent magnets 74A and 74B are configured to have opposing polarities. As illustrated in FIG. 9C, the permanent magnet 74A has the south pole (S) facing north, whereas the permanent magnet 74B has the north pole (N) facing north. The electrical current I_{COIL} will flow counterclockwise through the electromagnetic coil 76 to thereby cause the haptic actuator module 12 to generate the actuation force 18 in parallel to the touch surface 14 but perpendicular to the longitudinal axis 26.

FIG. 9D illustrates a cross-section view of the haptic actuator module 12 of FIG. 9C. Herein, the electromagnetic coil 76 is also disposed along the center line 78 of the permanent magnets 74A and 74B to help boost the actuation force 18 to the highest degree.

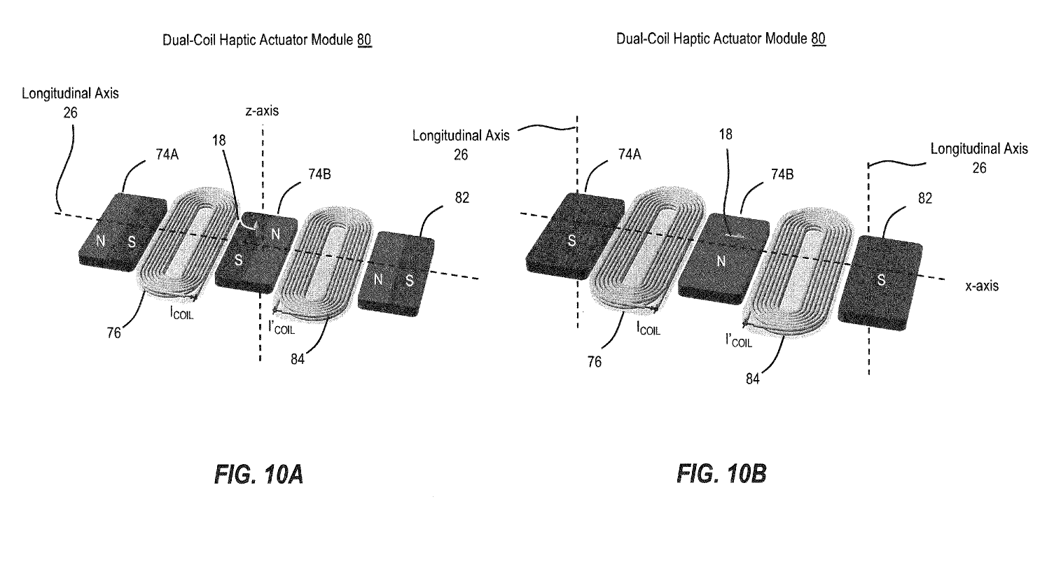

In another embodiment, it is also possible to boost the actuation force 18 in the haptic actuator module 12 by incorporating more permanent magnets and electromagnetic coils. In this regard, FIGS. 10A-10B are schematic diagrams providing exemplary illustrations as to how the haptic actuator module 12 assembled based on the in-plan configuration in FIGS. 9A-9D can be configured to boost the actuation force 18 according to another embodiment of the present disclosure.

FIG. 10A illustrates a dual-coil haptic actuator module 80 that can boost the actuation force 18 along the z-axis. In this embodiment, the dual-coil haptic actuator module 80 further includes a second permanent magnet 82 that is disposed coplanar with the permanent magnets 74A and 74B. Herein, the second permanent magnet 82 is disposed adjacent to the permanent magnet 74B and has an opposing polarity to the adjacent permanent magnet 74B. In this regard, the permanent magnet 74B is shared between the permanent magnet 74A and the second permanent magnet 82. Understandably, by sharing the permanent magnet 74B, it is possible to reduce bill-of-material (BOM) cost of the dual-coil haptic actuator module 80. Like the permanent magnets 74A and 74B, the second permanent magnet 82 is also oriented with the longitudinal axis 26 parallel to the touch surface 14 and the supporting structure 16.

The dual-coil haptic actuator module 80 also includes a second electromagnetic coil 84, which is disposed between the permanent magnet 74B and the second permanent magnet 82. Like the electromagnetic coil 76, the second electromagnetic coil 84 can be made with multiple layers as illustrated in FIGS. 4A-4C. The second electromagnetic coil 84 has a second electrical current I’_{COIL} flowing clockwise through the second electromagnetic coil 84. As such, the dual-coil haptic actuator module 80 can constructively boost the actuation force 18 along the z-axis.

FIG. 10B illustrates the dual-coil haptic actuator module 80 that can boost the actuation force 18 along the x-axis. Herein, the second permanent magnet 82 is disposed coplanar with the permanent magnets 74A and 74B. The second permanent magnet 82 is adjacent to the permanent magnet 74B and has an opposing polarity to the adjacent permanent magnet 74B. Like the permanent magnets 74A and 74B, the second permanent magnet 82 is also oriented with the longitudinal axis 26 perpendicular to the touch surface 14 and the supporting structure 16.

The second electromagnetic coil 84 is disposed between the second permanent magnet 82 and the adjacent permanent magnet 74B. Herein, the second electrical current I’_{COIL} is configured to flow clockwise through the second electromagnetic coil 84 to thereby boost the actuation force 18 along the x-axis and in parallel to the touch surface 14.

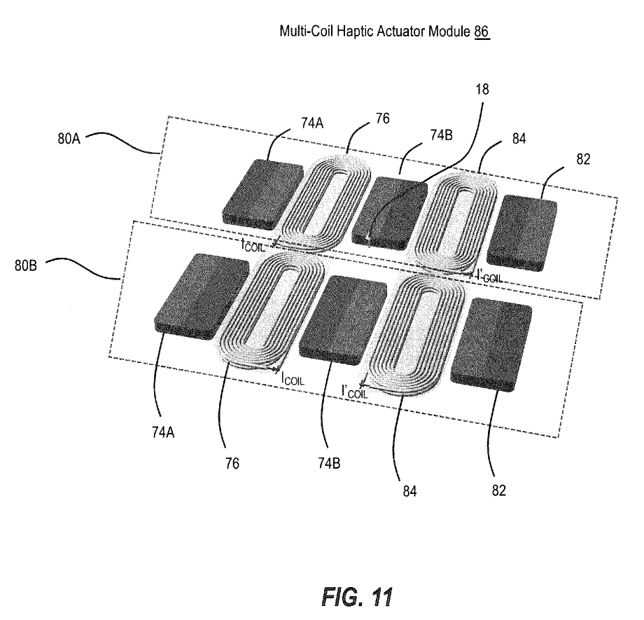

In an embodiment, it is possible to construct a multi-coil haptic actuator module based on the dual-coil haptic actuator module 80 to further boost the actuation force 18. In this regard, FIG. 11 is a schematic diagram of an exemplary multi-coil haptic actuator module 86 assembled based on the dual-coil haptic actuator module 80 in FIGS. 10A-10B to further boost the actuation force 18 along the z-axis.

Herein, the multi-coil haptic actuator module 86 includes a first dual-coil haptic actuator module 80A and a second dual-coil haptic actuator module 80B, each identical to the dual-coil haptic actuator module 80 of FIG. 10A. To ensure that the first dual-coil haptic actuator module 80A and the second dual-coil haptic actuator module 80B can constructively boost the actuation force 18 along the z-axis, each adjacent pair of the permanent magnets 74A and 74B, and the second permanent magnet 82 need to have opposing polarity. In addition, the electrical current I_{COIL} and the second electrical current I’_{COIL} must flow in opposite directions in each adjacent pair of the electromagnetic coil 76 and the second electromagnetic coil 84. Notably, the multi-coil haptic actuator module 86 is presented herein merely as a non-limiting example. It should be appreciated that the multi-coil haptic actuator module 86 can be adapted to incorporate any additional numbers of the dual-coil haptic actuator module 80.

Although the first dual-coil haptic actuator module 80A and the second dual-coil haptic actuator module 80B are each identical to the dual-coil haptic actuator module 80 of FIG. 10A, it should be appreciated that it is also possible to make each of the first dual-coil haptic actuator module 80A and the second dual-coil haptic actuator module 80B identical to the dual-coil haptic actuator module 80 of FIG. 10B. As such, the multi-coil haptic actuator module 86 will be able to boost the actuation force 18 along the x-axis or the y-axis.

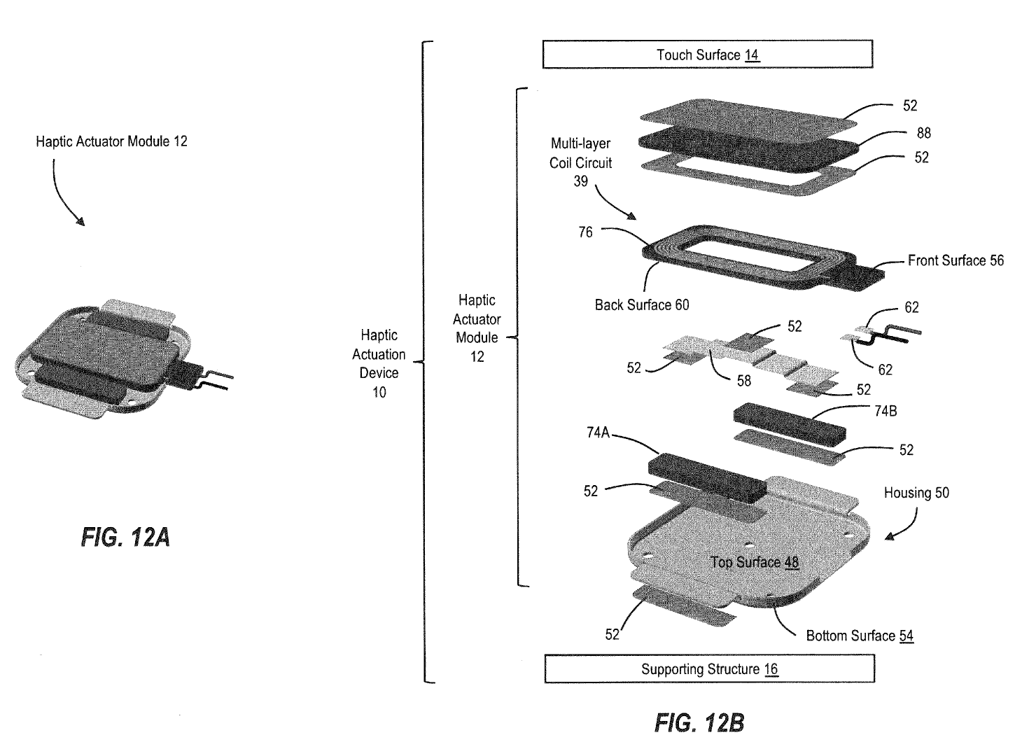

In an embodiment, the haptic actuator module 12 as configured based on the in-plane configuration in FIGS. 9A and 9B can be provided in the haptic actuation device 10 of FIG. 1. In this regard, FIGS. 12A-12B are schematic diagrams illustrating how the haptic actuation device 10 of FIG. 1 can be assembled with the haptic actuator module 12 configured based on the in-plane configuration in FIGS. 9A and 9B.

FIG. 12A illustrates the haptic actuator module 12 that has been preassembled according to an embodiment of the present disclosure and is ready to be provided in the haptic actuation device 10 of FIG. 1.

FIG. 12B provides an exploded view of the haptic actuator module 12 of FIG. 12A. The haptic actuator module 12 is assembled mostly like the dual-coil haptic actuator module 40 in FIG. 7B and will not be redescribed herein. Although the haptic actuation device 10 is assembled to include the haptic actuator module 12 as configured based on the in-plane configuration in FIGS. 9A and 9B, it should be appreciated that it is also possible to replace the haptic actuator module 12 with the dual-coil haptic actuator module 80 as illustrated in FIGS. 10A-10B.

A noticeable difference from the dual-coil haptic actuator module 40 in FIG. 7B, however, is that a shim 88 is attached to the front surface 56 using the adhesive material 52. The purpose of the shim 88 is to allow the multi-layer coil circuit 39 to be properly aligned with the center line 78 (as shown in FIGS. 9B and 9D). The shim 88 is bonded to the touch surface 14 via the adhesive material 52. Accordingly, the touch surface 14 will be bonded to the multi-layer coil circuit 39 via the shim 88.

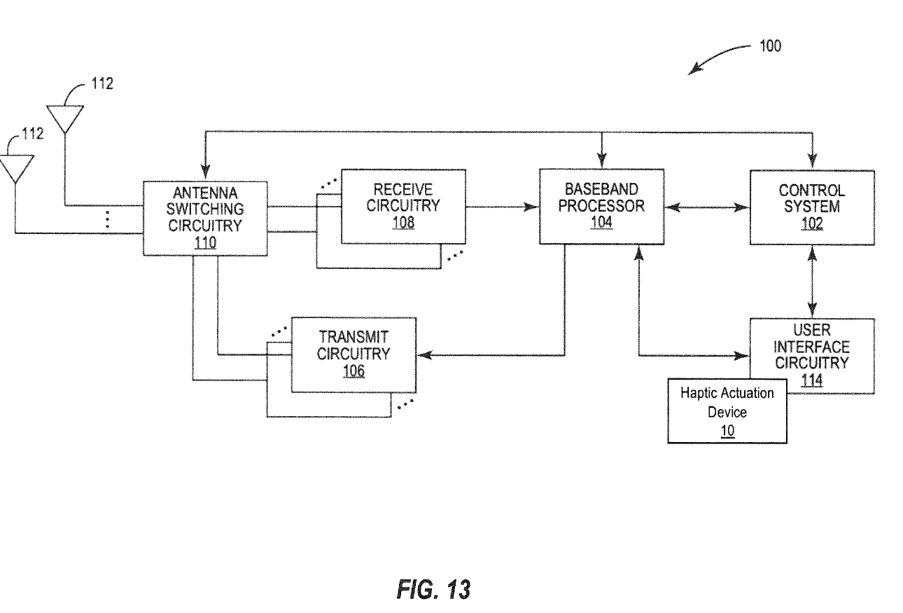

In an embodiment, the haptic actuation device 10 of FIG. 1 can be provided in various types of touch-based electronic devices, including but not limited to a touch-based wireless device. In this regard, FIG. 13 is a schematic diagram of an exemplary communication device 100 wherein the haptic actuation device 10 of FIG. 1 can be provided.

Herein, the communication device 100 can be any type of communication device, such as a mobile terminal, smart watch, tablet, computer, navigation device, access point, base station (e.g., eNB, gNB, etc.), and any other type of wireless communication device that support wireless communications, such as cellular, wireless local area network (WLAN), Bluetooth, Ultra-wideband (UWB), and near field communications. The communication device 100 will generally include a control system 102, a baseband processor 104, transmit circuitry 106, receive circuitry 108, antenna switching circuitry 110, multiple antennas 112, and user interface circuitry 114. In an embodiment, the haptic actuation device 10 of FIG. 1 can be provided in the user interface circuitry 114.

In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using an analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission, and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

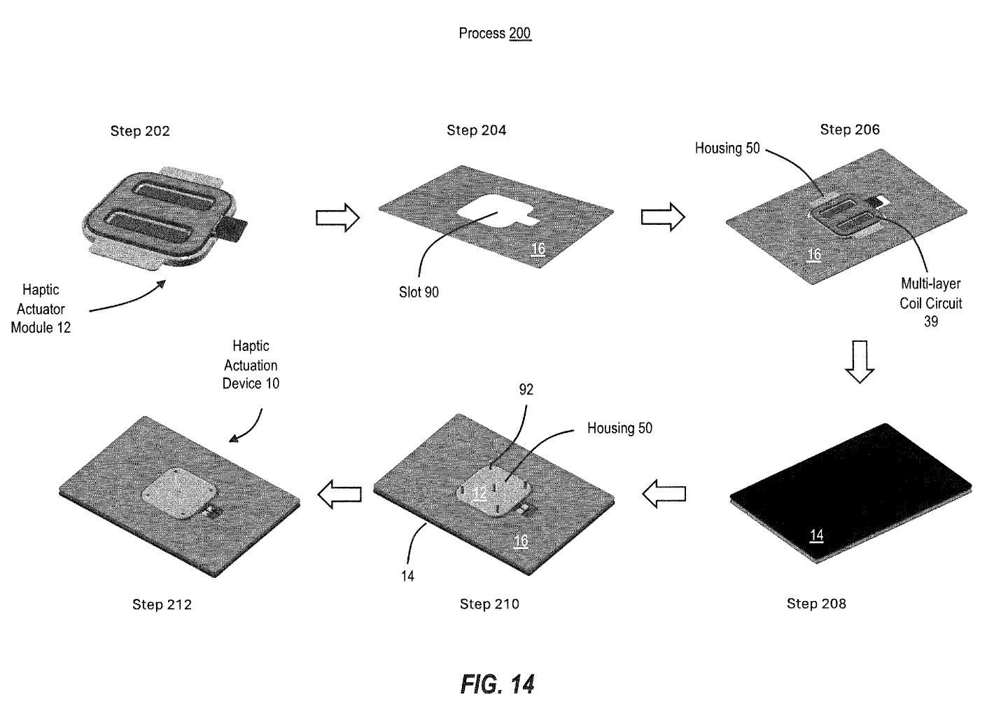

In an embodiment, the haptic actuation device 10 of FIG. 1 can be assembled in accordance with a process. In this regard, FIG. 14 is a flowchart of an exemplary process 200 for assembling the haptic actuation device 10 of FIG. 1.

The process 200 includes preassembling the haptic actuator module 12 (step 202). Herein, the haptic actuator module 12 can be assembled based on the out-of-plane configuration or the in-plane configuration. More specifically, the haptic actuator module 12 can be assembled as the dual-coil haptic actuator module 40 in FIGS. 5A and 5B, the multi-coil haptic actuator module 46 of FIG. 6, the dual-coil haptic actuator module 80 of FIGS. 10A and 10B, and the multi-coil haptic actuator module 86 of FIG. 11.

The process 200 also includes forming a slot 90 on the supporting structure 16 with a shape corresponding to that of the haptic actuator module 12 (step 204). The process 200 also includes disposing the haptic actuator module 12 into the slot 90 and adhering the housing 50 of the haptic actuator module 12 to the supporting structure 16 (step 206). The process 200 also includes adhering the multi-layer coil circuit 39 in the haptic actuator module 12 to the touch surface 14 (step 208).

The process 200 also includes pressing the housing 50 of the haptic actuator module 12 to securely bond the haptic actuator module 12 with the supporting structure 16 and the touch surface 14 (step 210). In an embodiment, the haptic actuation device 10 is flipped upside-down and a jig 92 with pins is used to push the haptic actuator module 12 down through the pins on the back of the housing 50 to thereby cause the adhesive material 52 to bond properly.

The process 200 also includes making an electrical connection to the haptic actuator module 12 (step 212). Notably, the electrical connection may also be performed in earlier steps, such as prior to adhering the multi-layer coil circuit 39 in the haptic actuator module 12 to the touch surface 14.

Those skilled in the art will recognize improvements and modifications to the preferred embodiments of the present disclosure. All such improvements and modifications are considered within the scope of the concepts disclosed herein and the claims that follow.

What is claimed is:

1. A haptic actuation device comprising:
a touch surface and a supporting structure disposed in parallel to each other; and
a haptic actuator module disposed between the touch surface and the
supporting structure and configured to generate an actuation force,
wherein the haptic actuator module comprises:
at least one permanent magnet disposed on the supporting structure; and
at least one electromagnetic coil defining a central aperture
vertically aligned with the at least one permanent magnet
and sized larger than the at least one permanent magnet
such that the at least one electromagnetic coil will not
physically contact the at least one permanent magnet when
moving into coplanarity with the at least one permanent
magnet.

2. The haptic actuation device of claim 1, wherein the at least one electromagnetic coil is disposed above and vertically separated from the at least one permanent magnet by a vertical distance.

3. The haptic actuation device of claim 1, wherein the at least one electromagnetic coil comprises multiple layers electrically coupled together to boost the actuation force.

4. The haptic actuation device of claim 1, wherein:
the at least one permanent magnet is oriented with a longitudinal axis
perpendicular to the touch surface and the supporting structure, a north pole facing the touch surface, and a south pole facing the supporting structure; and
the at least one electromagnetic coil has an electrical current flowing counterclockwise therethrough to cause the haptic actuator module to generate the actuation force toward the touch surface.

5. The haptic actuation device of claim 4, wherein the haptic actuator module further comprises:
at least one second permanent magnet disposed adjacent to the at least one permanent magnet and oriented with the longitudinal axis perpendicular to the touch surface and the supporting structure, the south pole facing the touch surface, and the north pole facing the supporting structure; and
at least one second electromagnetic coil disposed adjacent to the at least one electromagnetic coil and defining a second central aperture vertically aligned with the at least one second permanent magnet, the at least one second electromagnetic coil has a second electrical current flowing clockwise therethrough to cause the haptic actuator module to generate the actuation force toward the touch surface.

6. The haptic actuation device of claim 1, wherein:
the at least one permanent magnet is oriented with a longitudinal axis parallel to the touch surface and the supporting structure; and
the at least one electromagnetic coil has an electrical current flowing counterclockwise therethrough to cause the haptic actuator module to generate the actuation force in parallel to the touch surface.

7. The haptic actuation device of claim 6, wherein the haptic actuator module further comprises:
at least one second permanent magnet disposed on the supporting structure adjacent to the at least one permanent magnet and oriented with the longitudinal axis parallel to the touch surface and the supporting structure; and
at least one second electromagnetic coil disposed adjacent to the at least one electromagnetic coil and defining a second central aperture vertically aligned with the at least one second permanent magnet, the at least one second electromagnetic coil has a second electrical current flowing clockwise therethrough to cause the haptic actuator module to generate the actuation force in parallel to the touch surface.

8. The haptic actuation device of claim 1, wherein the haptic actuator module further comprises:
a housing having a bottom surface configured to be adhered to the supporting structure and a top surface whereto the at least one permanent magnet is adhered;
a printed circuit board (PCB) comprising one or more layers of the at least one electromagnetic coil and configured to be fully adhered to the touch surface over an entire front surface of the PCB; and
a spring adhered to the top surface of the housing and a back surface of the PCB to thereby secure the PCB to the housing.

9. The haptic actuation device of claim 1, wherein the haptic actuator module further comprises:
a housing having a bottom surface configured to be adhered to the supporting structure and a top surface whereto the at least one permanent magnet is adhered;
a printed circuit board (PCB) comprising one or more layers of the at least one electromagnetic coil and configured to be partially adhered to the touch surface along a perimeter region of a front surface of the PCB;
a force sensor provided in a center region of a back surface of the PCB and configured to detect a deflection of the center region of the PCB when an external force is applied onto the touch surface; and
a spring adhered to the top surface of the housing and the back surface of the PCB to thereby secure the PCB to the housing.

10. A wireless device comprising a haptic actuation device, the haptic actuation device comprises:
a touch surface and a supporting structure disposed in parallel to each other; and
a haptic actuator module disposed between the touch surface and the supporting structure and configured to generate an actuation force,
wherein the haptic actuator module comprises:
at least one permanent magnet disposed on the supporting structure; and at least one electromagnetic coil defining a central aperture vertically aligned with the at least one permanent magnet and sized larger than the at least one permanent magnet such that the at least one electromagnetic coil will not physically contact the at least one permanent magnet when moving into coplanarity with the at least one permanent magnet.

11. A haptic actuation device comprising:
a touch surface and a supporting structure disposed in parallel to each other; and
a haptic actuator module disposed between the touch surface and the supporting structure and configured to generate an actuation force, wherein the haptic actuator module comprises:
at least two permanent magnets disposed on the supporting structure; and
at least one electromagnetic coil disposed in between the at least two permanent magnets and coplanar with the at least two permanent magnets, the at least one electromagnetic coil defines a central aperture dimensioned independently of the at least two permanent magnets.

12. The haptic actuation device of claim 11, wherein the at least one electromagnetic coil is aligned with a center line of each of the at least two permanent magnets.

13. The haptic actuation device of claim 11, wherein the at least one electromagnetic coil comprises multiple layers electrically coupled together to boost the actuation force.

14. The haptic actuation device of claim 11, wherein:
the at least two permanent magnets are each oriented with a longitudinal axis parallel to the touch surface and the supporting structure, a north pole facing away from the at least one electromagnetic coil, and a south pole facing toward the at least one electromagnetic coil; and
the at least one electromagnetic coil has an electrical current flowing counterclockwise therethrough to cause the haptic actuator module to generate the actuation force toward the touch surface.

15. The haptic actuation device of claim 14, wherein the haptic actuator module further comprises:
at least one second permanent magnet disposed on the supporting structure and coplanar with the at least two permanent magnets, the at least one second permanent magnet is oriented with the longitudinal axis parallel to the touch surface and the supporting structure and having an opposing polarity to an adjacent one of the at least two permanent magnets; and
at least one second electromagnetic coil disposed between the at least one second permanent magnet and one of the at least two permanent magnets adjacent to the at least one second permanent magnet and having a second electrical current flowing clockwise therethrough to cause the haptic actuator module to generate the actuation force toward the touch surface.

16. The haptic actuation device of claim 11, wherein:
the at least two permanent magnets are each oriented with a longitudinal axis perpendicular to the touch surface and the supporting structure and having opposing polarities; and
the at least one electromagnetic coil has an electrical current flowing counterclockwise therethrough to cause the haptic actuator module to generate the actuation force in parallel to the touch surface.

17. The haptic actuation device of claim 16, wherein the haptic actuator module further comprises:
at least one second permanent magnet disposed on the supporting structure and coplanar with the at least two permanent magnets, the at least one second permanent magnet is oriented with the longitudinal axis perpendicular to the touch surface and the supporting structure and having an opposing polarity to an adjacent one of the at least two permanent magnets; and
at least one second electromagnetic coil disposed between the at least one second permanent magnet and one of the at least two permanent magnets adjacent to the at least one second permanent magnet and having a second electrical current flowing clockwise therethrough to cause the haptic actuator module to generate the actuation force in parallel to the touch surface.

18. The haptic actuation device of claim 11, wherein the haptic actuator module comprises:
a housing having a bottom surface configured to be adhered to the supporting structure and a top surface whereto the at least two permanent magnets are adhered;
a printed circuit board (PCB) comprising one or more layers of the at least one electromagnetic coil and configured to be fully adhered to the touch surface over an entire front surface of the PCB; and
a spring adhered to the top surface of the housing and a back surface of the PCB to thereby secure the PCB to the housing.

19. A wireless device comprising a haptic actuation device, the haptic actuation device comprises:
a touch surface and a supporting structure disposed in parallel to each other; and
a haptic actuator module disposed between the touch surface and the supporting structure and configured to generate an actuation force, wherein the haptic
actuator module comprises:
at least two permanent magnets disposed on the supporting structure; and
at least one electromagnetic coil disposed in between the at least two permanent magnets and coplanar with the at least two permanent magnets, the at least one electromagnetic coil defines a central aperture dimensioned independently of the at least two permanent magnets.

20. A method for assembling a haptic actuation device comprising:
preassembling a haptic actuator module;
forming a slot on a supporting structure with a shape corresponding to that of the haptic actuator module;
disposing the haptic actuator module into the slot and adhering a housing of the haptic actuator module to the supporting structure;
adhering a multi-layer coil circuit in the haptic actuator module to a touch surface;
pressing the housing of the haptic actuator module to securely bond the haptic actuator module with the supporting structure and the touch surface; and
making an electrical connection to the haptic actuator module.
